(19) United States
(12) Patent Application Publication
(10) Pub. No.: US 2007/0292108 A1
(43) Pub. Date: Dec. 20, 2007

(54) Method and system for processing digital video

(75) Inventors: David Anthony Reichert, Orange, CA (US); Kenneth Arlen Brady, Trabuco Canyon, CA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 11/453,752

(22) Filed: Jun. 15, 2006

(51) Int. Cl. H04N 5/91

(52) U.S. Cl. 386/68

(57) ABSTRACT

A method and system for processing digital video is described. The invention permits fast forwarding, rewinding, pausing and resuming a digital video that is delivered over a computer network. In various embodiments of the invention, reduced-information frames (e.g., P-frames and B-frames) are skipped, samplings of complete frames (e.g., I-frames) are transmitted, and delay predictions are made to compensate for the lag time to enhance pause/resume functionality. The invention can be used delivering digital video in a low bandwidth environment. Moreover, the invention can be used in conjunction with any video standard in which there are a mix of full frames and reduced-information frames.

### TECHNICAL FIELD

This invention relates generally to digital video, and, more particularly, to methods and systems for fast forwarding, rewinding, or resuming the play of a digital video.

### BACKGROUND

Modern digital video standards, including the ubiquitous Motion Picture Expert Group (MPEG) family of standards, employ a number of compression techniques. For example, in MPEG videos, only a minority of frames actually contain a complete, standalone picture. Such frames are known as “intraframes” or I-frames. The rest of the frames contain a reduced set of information, in which a complete image that can only be constructed by reference to other frames, including the I-frames. These reduced-information frames are known as “predicted frames” or P-frames, and “bidirectional frames” or B-frames. An MPEG video stream includes a number of I-frames, often separated from one another by a larger number of P-frames and B-frames. Although the P-frames and B-frames do not, by themselves, define a complete image, they contain sufficient information to permit an MPEG player to reconstruct complete images by using a series of algorithms and by referring to the I-frames.

To fast-forward or rewind an MPEG video, an MPEG player only processes some of the frames of the video. Typically, these will be I-frames and B-frames. Under normal circumstances, this method is acceptable. However, there are certain situations in which bandwidth is at a premium, such as when the frames are going to be transmitted over a network, and thus the number of frames needs to be reduced even further.

### SUMMARY

In accordance with the foregoing, a method for processing video data is provided. In an embodiment of the invention, the method includes reading video data from a digital storage device (which may be a hard drive, digital versatile disc (DVD) player, or flash memory device) and converting the video data into a format that includes a first plurality of image frames, each of which represents an entire image, and a second plurality of images frames, each of which represents less than an entire image. Upon receiving a command to scan through video data (such as a fast forward or rewind command), a stream of data that includes less than all of the first plurality of image frames and none of the second plurality of image frames is transmitted. In one embodiment, each of the first plurality of frames is an I-frame and each of the second plurality of frames is a P-frame or a B-frame.

The method may further include converting the video data into a bit stream that contains both the first plurality and second plurality of image frames, skipping all of the second plurality of image frames and at least some of the first plurality of image frames, and selecting the non-skipped image frames of the first plurality to include into a modified bit stream.

In another embodiment of the invention, video display unit communicatively linked to a computer network receives a rewind command from a user, and transmits the rewind command. A video server communicatively linked to the computer network converts a video into a format that includes a first plurality of image frames, each of which represents an entire image (e.g. an I-frame), and a second plurality of images frames, each of which represents less than an entire image (e.g. a P- or B-frame). The video server receives the rewind command and, if the video is in a play mode when the rewind command is received, transmits all of the first plurality of image frames in reverse order to the video display unit. If the video is in a rewind mode when the video server receives the rewind command, the video server transmits fewer than all of the first plurality of image frames in reverse order to the video display unit. The video server can also check each of the image frames to determine whether there are any duplicates, and refrain from transmitting those duplicates.

In yet another embodiment, the video server is capable of putting the video into multiple fast forward or rewind modes. In at least one fast forward mode and at least one rewind mode, all of the first plurality of image frames (e.g. all I-frames), but none of the second plurality (e.g. no P- or B-frames) are transmitted to the video display unit. In another of the fast forward or rewind modes, less than all of the first plurality of image frames are transmitted.

In still another embodiment, the video server can switch a video from a fast forward or rewind mode to a play mode, and, in doing so, compensates for the lag time between the user transmitting the command and the command being processed by the video server. This compensation is accomplished by reversing the video slightly prior to resuming play (in the case of switching from fast forward to play) or by advancing the video slightly prior to resuming play (in the case of switching from rewind to play).

### BRIEF DESCRIPTION OF THE DRAWINGS

FIG. 1 is a block diagram of a video server configured according to an embodiment of the invention.

FIG. 2 is a block diagram of a computer network according to an embodiment of the invention, of which the video server of FIG. 1 is a node.

### DETAILED DESCRIPTION

The invention is generally directed to a method and system for processing digital video and, more specifically, for fast forwarding, rewinding, and resuming the play of a digital video that is delivered over a computer network. In various embodiments of the invention, reduced-information frames (e.g., P-frames and B-frames) are skipped, samplings of complete frames (e.g., I-frames) are transmitted, and delay predictions are made to compensate for the lag time to enhance pause/resume functionality. The invention can be used delivering digital video in a low bandwidth environment. Moreover, the invention can be used in conjunction with any video standard in which there are a mix of full frames and reduced-information frames.

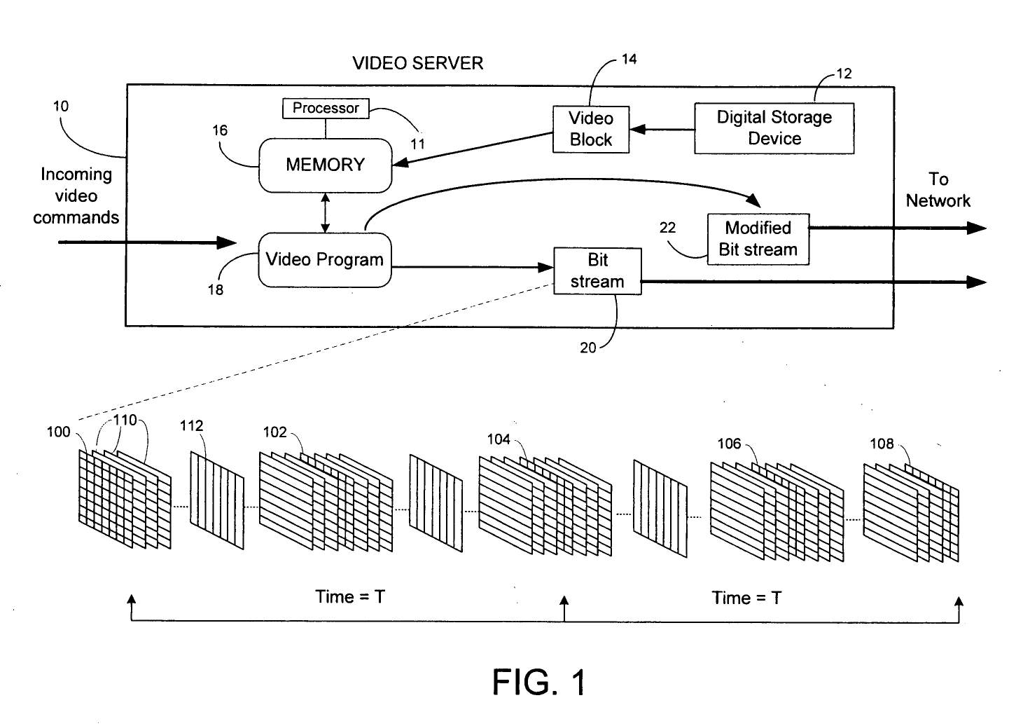

An embodiment of the invention will now be described in the context of an in-flight entertainment system that is deployed on a passenger jet. Referring to FIG. 1, a video server, generally labeled 10, is communicatively linked to a computer network. The video server 10 includes a processor 11, a digital storage device 12 controlled by the processor 11, and a memory 16 accessible by the processor 11. The processor 11 executes a video program 18. Possible implementations of the digital storage device 12 include a hard drive, DVD player, and a flash memory device. Under control of the processor 11 and the digital storage device 12, a block 14 of encoded video data (e.g., a 512 kilobyte block) is read from the digital storage device 12 into the memory 16. The block 14 is then processed by the video program 18 and converted into a bit stream 20 which, in this example, is an MPEG bit stream. The bit stream 20 includes a series of frames in the sequence shown (starting from the left). The series includes a first I-frame 100, a second I-frame 102, a third I-frame 104, a fourth I-frame 106, and a fifth I-frame 108. Between the various I-frames are B-frames 110 and P frames 112. It is understood that the number of B-frames and P-frames can vary, as can the number of I-frames. It is also understood that the I-frames, B-frames and P-frames shown in FIG. 1 are merely representative, and that in fact there may be numerous frames in the bit stream 20.

The video program 18 receives incoming video commands from the network. In response to certain commands, such as normal-speed PLAY, the video program transmits the bit stream 20 to the network. In response to other commands, such as REWIND and FAST FORWARD commands, the video program 18 processes the bit stream 20 to create a modified bit stream 22. The bit stream 20 or the modified bit stream 22 is then packetized and transmitted to the network. In one embodiment, the bit stream 20 or the modified bit stream 22 is packetized into Real-Time Transport Protocol (RTP) packets. The RTP packets are themselves then packetized according to a User Datagram Protocol over Internet Protocol (UDP/IP). The UDP/IP packets are then transmitted to the network as part of Ethernet frames. The process by which the video program 18 creates the modified bit stream 22 will be described in more detail below. It is to be noted that the modified bit stream 22 is transmitted to the network at the same rate as the bit stream 20 (e.g., 2 Megabits per second). However, the modified bit stream 22 contains only a subset of the data that is contained in the bit stream 20. Thus, the modified bit stream 22 consumes less bandwidth on the network than other techniques for fast forward/rewind.

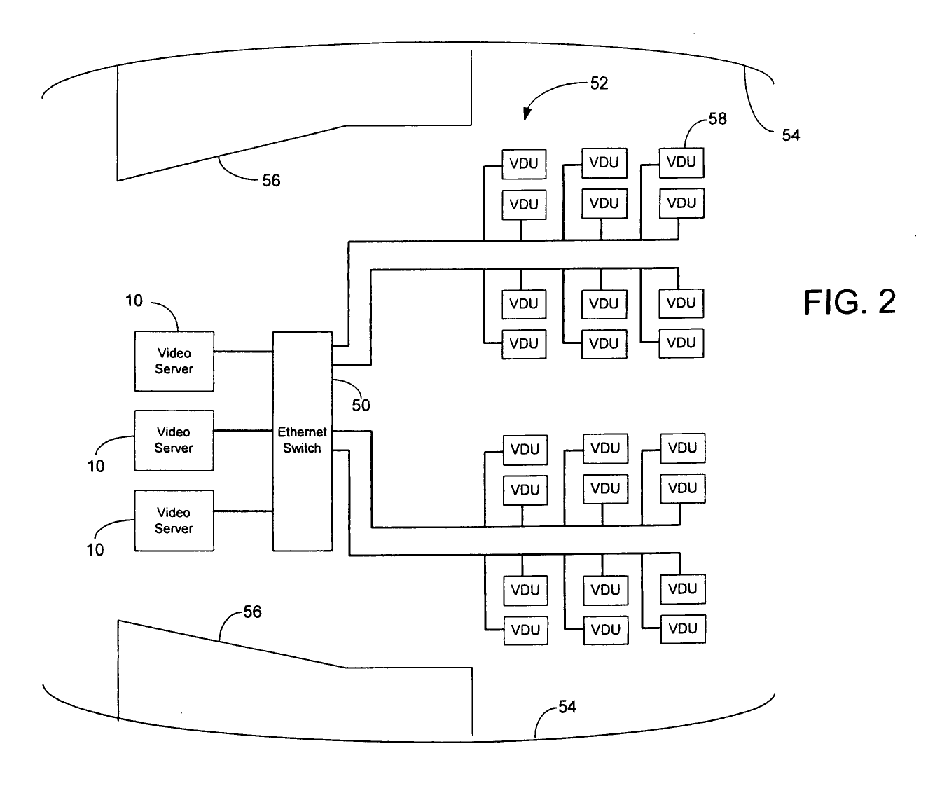

Referring now to FIG. 2, an example of a computer network in which the video server 10 of FIG. 1 may be deployed will now be described. The video server 10 is one of three video servers that are communicatively linked to, and function as part of, a computer network 52. Any number of video servers 10 is possible (as many as 20 video servers, in one embodiment), and the number depicted in FIG. 2 is merely illustrative. The computer network 52 is integrated with an in-flight entertainment system. As such, the computer network 52 is located within the cabin of an aircraft, inside the fuselage. Parts of the computer network 52, such as Ethernet cables, are attached to the bulkhead 54 of the cabin, while other parts are located beneath the cabin floor 56 (a cutaway of which is shown). In addition to the video servers 10, the computer network 52 includes an Ethernet switch 50 and video display units (VDUs) 58. The Ethernet switch 50 is communicatively linked to the video servers 10 and to the VDUs 58. Each VDU 58 is located adjacent to a passenger seat such that, when deployed, it is visible to the passenger in that seat. Using controls on (or attached to) the VDUs 58, the passengers on the aircraft can request video content (e.g., movies, TV shows, news programs), which are then delivered by one or more of the video servers 10 to the VDUs 58 in the form of an MPEG bit stream or, as will be described below, a modified MPEG bit stream. Each VDU 58 includes an MPEG decoder that interprets the received bit stream and converts the bit stream into moving images that are displayed on a display screen of the VDU 58. The moving images will be referred to herein as the “video,” but it is to be understood that “video” may include any kind of video content.

To play, fast forward, rewind, pause, or resume a video, a passenger manipulates a set of controls (e.g., a handheld unit) that are linked to the VDU 58. In one embodiment, the video controls include a PLAY/PAUSE button, which permits the passenger to toggle between playing and pausing a video and to resume playing a video that is currently being fast forwarded or rewound. The video controls also include a FAST FORWARD button and a REWIND button. The FAST FORWARD and REWIND buttons each allow the passenger to fast forward or rewind a video at different speeds (each speed being selected by successive presses of the button), including a first speed, a second speed, and a third speed. At the first FAST FORWARD and first REWIND speeds, the video advances or reverses at 3 times the regular PLAY speed. At the second FAST FORWARD and second REWIND speeds, the video advances or reverses at 9 times the regular PLAY speed. At the third FAST FORWARD and third REWIND speeds, the video advances or reverses at 30 times the regular PLAY speed. In response to the passenger's input, the VDU 58 sends corresponding video commands to one of the video servers 10. The video server 10 responds by reading data from the digital storage device 12 (FIG. 1) if it has not already done so, creating the appropriate bit stream, modifying the bit stream (if a FAST FORWARD or REWIND command is received), and transmitting the bit stream over the network 52 to the VDU 58.

In an embodiment of the invention, when the video server 10 receives a FAST FORWARD command from a VDU 58, it responds by creating a modified bit stream 22 and transmitting the modified bit stream 22 to the VDU 58. The modified bit stream 22 will give the passenger the effect of having the video fast forwarded, but will consume less bandwidth on the network 52 than conventional fast forwarding methods. An example of how this is accomplished will now be described. In this example, it is assumed that the most recent frame that was transmitted to the VDU 58 is the first I-frame 100 (FIG. 1). It is also assumed that the command received represents the first FAST FORWARD speed. Instead of processing the P-frame immediately following the first I-frame 100, the video program 18 skips ahead to the second I-frame 102, then to the third I-frame 104, and so on. The video program then puts all of the I-frames into the modified bit stream, but no P- or B-frames.

Another example of how the modified bit stream 22 is created from the bit stream 20 will now be described. In this example, it is again assumed that the most recent frame that was transmitted to the VDU 58 is the first I-frame 100 (FIG. 1). In contrast to the previous example, however, it now assumed that the command received from the VDU 58 represents the second or third FAST FORWARD speed. Instead of processing the P-frame immediately following the first I-frame 100, the video program 18 skips ahead for a predetermined period of time, represented in FIG. 1 by T, locates the I-frame that occurs in the stream after that predetermined period of time, and puts that I-frame into the modified bit stream 22. In the example of FIG. 1, the first I-frame that occurs following the predetermined period of time T is the third I-frame 106. The video program 18 then repeats this process, skipping forward the period of time T, and locates the next I-frame, which is the fifth I-frame 108, and puts it into the modified bit stream 22. Repeating the process again, the video program 18 puts the fifth I-frame 108 into the modified bit stream 22. The modified bit stream 22 is then transmitted to the VDU 58. As a result, the modified bit stream 22 includes less than all of the I-frames and none of the P- or B-frames. Note that the difference between the second and third FAST FORWARD speeds is that time T for the third FAST FORWARD speed is greater than time T for the second FAST FORWARD speed.

In an embodiment of the invention, the procedure described above for the FAST FORWARD function may also be used by the video server 10 to carry out a REWIND function. For example, when the video server 10 receives, from one of the VDUs 58, a command representing the first REWIND speed, the video program 18 (FIG. 1) reads in the prior video block 14 (i.e., the video block just before the one most recently processed) from the digital storage device 12, and converts the video block 14 into a bit stream 20. The video program 18 then advances forward in the bit stream 20 until it locates the last I-frame. It then puts the I-frame into the modified bit stream 22, moves backward through the bit stream 20, locates the next I-frame, puts that I-frame into the modified bit stream 22, and so on. For example, assume that the previous video block is the video block 14 shown in FIG. 1, and that the resulting bit stream is the bit stream 20 shown in FIG. 1. The video program 18 locates the last I-frame in the bit stream 20 which, in this example, is the fifth I-frame 108. The video program 18 puts the fifth I-frame 108 into the modified bit stream 22. Then, the video program 18 skips back through the bit stream 20, and looks for the I-frame it can find at that point which, in this example, is the fourth I-frame 106. The video program 18 puts the fourth I-frame 106 into the modified bit stream (in sequence after the fifth I-frame 108). This process is repeated until all of the I-frames, but no P- or B-frames, for the block have been inserted into the modified bit stream 22. The video program 18 then transmits the modified bit stream 22 to the VDU 58 (FIG. 2). The VDU 58 displays images based on the modified bit stream, which appear to the passenger as the video moving backwards.

In another example of the REWIND function, when the video server 10 receives a command representing the second or third REWIND speed, the video program 18 (FIG. 1) reads in the prior video block 14 (i.e., the video block just before the one most recently processed) from the digital storage device 12, and converts the video block 14 into a bit stream 20. The video program 18 then advances forward in the bit stream 20 until it locates the last I-frame. It then puts the I-frame into the modified bit stream 22, moves backward through the bit stream 20 for a predetermined time T, locates the next I-frame, puts that I-frame into the modified bit stream 22, and so on. For example, assume that the previous video block is the video block 14 shown in FIG. 1, and that the resulting bit stream is the bit stream 20 shown in FIG. 1. The video program 18 locates the last I-frame in the bit stream 20 which, in this example, is the fifth I-frame 108. The video program 18 puts the fifth I-frame 108 into the modified bit stream 22. Then, the video program 18 skips back through the bit stream 20 for time T, and looks for the I-frame it can find at that point which, in this example, is the third I-frame 104. The video program 18 puts the third I-frame 104 into the modified bit stream (in sequence after the fifth I-frame 108). The video program 18 repeats this process, putting the first I-frame 100 into the modified bit stream 22 after the fifth and third I-frames 108 and 104. The video program 18 then transmits the modified bit stream 22 to the VDU 58 (FIG. 2). The modified bit stream 22 in this example contains less than all of the I-frames and none of the P- or B-frames. The VDU 58 displays images based on the modified bit stream, which appear to the passenger as the video moving backwards. Note that the difference between the second and third REWIND speeds is that time T for the third REWIND speed is greater than time T for the second REWIND speed.

In one embodiment of the invention, the video program 18 also performs a duplication check during each of the REWIND modes. In other words, as the video program 18 skips back to each previous I-frame, it checks the I-frame to make sure that the I-frame has not previously been transmitted to the VDU 58. If it determines that the I-frame has already been sent to the VDU 58, then the video program 18 does not put that I-frame into the modified bit stream, bit instead skips back to next I-frame that it can find (whether the next one, as in the case of the first REWIND mode, or the next one after time T, as in the second or third REWIND modes).

In an embodiment of the invention, a passenger can cause a video to drop out of the FAST-FORWARD or REWIND mode and into the PLAY mode by pressing the PLAY/PAUSE button on the passenger controls. This action causes the VDU 58 to issue a PLAY command to the video server 10. In order to compensate for the lag between the time that the passenger presses the PLAY/PAUSE button and the time that the video server 10 receives the PLAY command, the video program 18 advances the video slightly (when switching from REWIND to PLAY) or reverses the video slightly (when switching from FAST FORWARD to PLAY). For example, when the video is in one of the FAST FORWARD modes and the video program 18 receives a PLAY command, the video program 18 compensates for the lag by skipping back for a number of frames corresponding to the estimated lag time, and resuming the bit stream from that point. If, for example, the video server 10 receives the PLAY command when the bit stream has advanced to the fifth I-frame 108 (FIG. 1), and the video program 18 estimates that the lag time is equal to T, then, upon receiving the PLAY command from VDU 58, the video program skips back to the third I-frame 104. The video program 18 then sends the bit stream 20 to the VDU 58 starting with the third I-frame 104. Thus, from the passenger's point of view, the video will have been properly resumed from the point at which the passenger had intended the FAST FORWARD operation to be halted.

In another example, when the video is in one of the REWIND modes and the video program 18 receives a PLAY command, the video program 18 compensates for the lag by skipping forward for a number of frames corresponding to the estimated lag time, and resuming the bit stream from that point. If, for example, the video server 10 receives the PLAY command when the bit stream has reversed to the third I-frame 104 (FIG. 1), and the video program 18 estimates that the lag time is equal to T, then, upon receiving the PLAY command from VDU 58, the video program skips forward to the fifth I-frame 108. The video program 18 then sends the bit stream 20 to the VDU 58 starting with the fifth I-frame 104. Thus, from the passenger's point of view, the video will have been properly resumed from the point at which the passenger had intended the REWIND operation to be halted.

It can thus be seen that a new and useful method and system for processing digital video has been described. Note that there are many possible variations of the embodiments described herein that fall within the scope of the following claims. Additionally, every implementation and configuration described herein is meant to be an example only and should not be taken as limiting the scope of the claims. Also, note that he use of the terms “a” and “an” and “the” and similar referents in the context of describing the invention (especially in the context of the following claims) are to be construed to cover both the singular and the plural. Finally, the steps of all methods described herein can be performed in any suitable order unless otherwise indicated herein or otherwise clearly contradicted by context.

What is claimed is:

1. A method for processing video data, the method comprising:
reading video data from a digital storage device;
converting the video data into a format that includes a first plurality of image frames, each of which represents an entire image, and a second plurality of images frames, each of which represents less than an entire image;
receiving a command to scan through video data; and
transmitting, in response to the command, a stream of data that includes less than all of the first plurality of images frames and none of the second plurality of image frames.

2. The method of claim 1, wherein the digital storage device is selected from a group consisting of a hard drive, a digital versatile disc player, and a flash memory device.

3. The method of claim 1, wherein the command to scan through the video data is a rewind command.

4. The method of claim 1, wherein the command to scan through the data is a fast forward command.

5. The method of claim 1, wherein each of the first plurality of images frames is an I-frame.

6. The method of claim 1, wherein each of the second plurality of image frames comprises a P-frame.

7. The method of claim 1, wherein each of the second plurality of image frames comprises a B-frame.

8. The method of claim 1, wherein the format into which the video data is converted is a Moving Pictures Expert Group (MPEG) format.

9. The method of claim 1, further comprising converting the video data into a bit stream that contains both the first plurality and second plurality of image frames, skipping all of the second plurality of image frames and at least some of the first plurality of image frames, and selecting the non-skipped image frames of the first plurality to include into a modified bit stream.

10. A method for rewinding a video, the method comprising:
on a video display unit communicatively linked to a computer network, performing steps comprising:
receiving a rewind command from a user;
transmitting the rewind command;
on a video server communicatively linked to the computer network, performing steps comprising
converting the video into a format that includes a first plurality of image frames, each of which represents an entire image, and a second plurality of images frames, each of which represents less than an entire image;
receiving the rewind command;
if the video is in a play mode when the rewind command is received, transmitting all of the first plurality of image frames in reverse order to the video display unit; and
if the video is in a rewind mode when the rewind command is received, transmitting fewer than all of the first plurality of image frames in reverse order to the video display unit.

11. The method of claim 10, further comprising:
checking at least one of the first plurality of image frames to determine whether the image frame has been previously transmitted to the video display unit; and
if the image frame has been previously transmitted, refraining from transmitting the image frame to the video display unit.

12. The method of claim 10, wherein each of the first plurality of images frames comprises an I-frame.

13. The method of claim 10, wherein each of the second plurality of image frames comprises a P-frame.

14. The method of claim 10, wherein each of the second plurality of image frames comprises a B-frame.

15. A method for fast forwarding a video, the method comprising:
on a video display unit communicatively linked to a computer network, performing steps comprising:
receiving a fast forward command from a user;
transmitting the fast forward command;
on a video server communicatively linked to the computer network, performing steps comprising
converting the video into a format that includes a first plurality of image frames, each of which represents an entire image, and a second plurality of images frames, each of which represents less than an entire image;
receiving the fast forward command;
if the video is in a play mode when the fast forward command is received, transmitting all of the first plurality of image frames to the video display unit; and
if the video is in a fast forward mode when the fast forward command is received, transmitting fewer than all of the first plurality of image frames to the video display unit.

16. The method of claim 15, wherein each of the second plurality of image frames comprises a P-frame.

17. The method of claim 15, wherein each of the second plurality of image frames comprises a B-frame.

18. A method for putting a video into play mode, the method comprising:
reading the video from a digital storage device;
transmitting a first bit stream to a video display unit, the first bit stream comprising a plurality of full image frames;
receiving, via a computer network, a play command from the video display unit;
if the video is a currently in a fast forward mode, performing steps comprising: reversing the video for a number of frames corresponding to a predetermined period of time and, after the reversing step, playing the video;
if the video is a currently in a reverse mode, performing steps comprising: advancing the video for a number of frames corresponding to a predetermined period of time and, after the advancing step, playing the video; and
transmitting a second bit stream to the video display unit, the second bit stream representing the video being played, the second bit stream comprising the plurality of full image frames and a plurality of partial image frames.

19. The method of claim 18, wherein the digital storage device is selected from a group consisting of a hard drive, a digital versatile disc player, and a flash memory device.

20. The method of claim 18, wherein the full image frames comprise I-frames.

21. The method of claim 18, wherein the partial image frames comprise P-frames.

22. The method of claim 18, wherein full image frames comprise Moving Pictures Expert Group (MPEG) I-frames, and the partial image frames comprise MPEG P-frames and MPEG B-frames.

23. The method of claim 18, wherein the computer network is part of an in-flight entertainment network and is located on board an aircraft.

24. A system for processing digital video on an aircraft, the system comprising:
a computer network;
a video display unit disposed proximate to a passenger seat on the aircraft, the video display unit comprising a display screen and a passenger control, the video display unit being communicatively linked to the computer network, the video display unit executing software for transmitting rewind commands and fast forward commands; and
a video server communicatively linked to the computer network, the video server executing software for receiving the rewind commands and fast forward commands from the video display unit and placing a video into one of a plurality of rewind modes and one of plurality of fast forward modes in response thereto, the video comprising a first plurality of image frames and a second plurality of image frames,
each of the first plurality of image frames defining a complete image by itself,
each of the second plurality of images frames defining a partial image by itself, and defining a complete image by referencing one or more of the first plurality of image frames,
wherein in at least one of the fast forward modes and at least one of the rewind modes, the video server transmits all of the first plurality of image frames to the video display unit and none of the second plurality of image frames to the video display unit,
wherein in at least one of the fast forward modes and at least one of the rewind modes, the video server transmits fewer than all of the first plurality of image frames to the video display unit and none of the second plurality of image frames to the video display unit.
